(19) United States
(12) Patent Application Publication
(10) Pub. No.: US 2016/0207058 A1
(43) Pub. Date: Jul. 21, 2016

(54) MOBILE MISTING COOLING APPARATUS

(71) Applicant: Stone Page Mangum, Winter Springs, FL (US)

(72) Inventor: Stone Page Mangum, Winter Springs, FL (US)

(21) Appl. No.: 15/000,461

(22) Filed: Jan. 19, 2016

Related U.S. Application Data
(60) Provisional application No. 62/104,991, filed on Jan. 19, 2015.

(51) Int. Cl. B05B 9/04; B05B 15/06; B05B 9/043

(52) U.S. Cl. CPC B05B 9/0423; B05B 9/043; B05B 15/061

(57) ABSTRACT

A mobile, attachable, detachable misting cooling apparatus. The apparatus conveys a cooling liquid through a plurality of misting elements removably attached to a portable frame structure. The apparatus may include a reservoir containing a volume of cooling liquid and a pump powered by a battery and rechargeable by power source operable to direct the cooling fluid through the misting elements.

### CROSS-REFERENCE TO RELATED APPLICATION

This application claims the benefit of priority of U.S. provisional application No. 62/104,991, filed Jan. 19, 2015, the contents of which are herein incorporated by reference.

### BACKGROUND OF THE INVENTION

The present invention relates to cooling devices and, more particularly, to a mobile misting cooling apparatus.

During the course of a hot day, under an open air canopy (i.e. set up at a beach, sports game, corporate or personal event, barbeque or any and all outdoor events) one's body heats up to uncomfortable and often dangerous levels, especially if there is no wind, dry wind and high humidity. A person becomes aware immediately of the intense heat and does not have a cooling source to cool them down on an ongoing basis that immediately reduces their body temperature. Cooling systems in the art are expensive, burdensome, not mobile and only for corporate brick and mortar use.

As can be seen, there is a need for a mobile misting cooling apparatus.

### SUMMARY OF THE INVENTION

In one aspect of the present invention, a mobile cooling apparatus, comprises: a portable liquid reservoir, a pump, having an inlet and an outlet; a battery with rechargeable external power source, a tubing element adapted to be coupled with an outlet of the pump; and a plurality of misters adapted to be operatively coupled to the tubing element. The mobile cooling apparatus may also comprise a portable frame structure, wherein the plurality of misters are removably attached to the portable frame structure in a spaced apart relation. A fastener operable to removably attach the tubing element to the portable frame structure. The fastener may comprise a hook and pile strap or a tie-wrap. A distribution connector may also be included which operatively connects between a plurality of tubing elements. The mobile cooling apparatus may further comprise a cooling fluid contained in the portable liquid reservoir.

According to aspects of the invention, the pump is adapted to communicate the cooling fluid through the plurality of misters. The pump may be contained in a pump housing along with an electrical source for powering the pump. The electrical source may comprise a battery contained within the pump housing. In some embodiments, the pump housing may include an external power connector, conducting an external electrical source to at least one of the pump or the battery.

In yet other aspects of the invention a mobile misting cooling apparatus comprises: a reservoir container; a pump connected to the reservoir container; a plurality of misters; and a tube connected to the pump and reservoir container, wherein the tube communicates a liquid from the tube to one of the plurality of misters. The mobile misting cooling apparatus may also comprise a frame structure, wherein the tube is removably attached to the frame structure. The frame structure may also include a canopy covering at least a top portion of the frame structure. A pump housing may contain the pump and an electrical source to operate the pump. A distribution connector may also be provided for operatively connecting a plurality of tubes to allow distribution of the liquid between each of the plurality of tubes.

These and other features, aspects and advantages of the present invention will become better understood with reference to the following drawings, description and claims.

### BRIEF DESCRIPTION OF THE DRAWINGS

FIG. 1 is a perspective view of the invention shown in use with item 12 tent canopy shown hidden for illustrative clarity.

FIG. 2 is a perspective detail view of the invention shown in use.

FIG. 3 is a partial section detail view of the invention along line 3-3 in FIG. 2.

FIG. 4 is a perspective detail view of the invention.

FIG. 5 is a perspective detail view of the invention shown with item 36 pump/battery container lid omitted for illustrative clarity.

FIG. 6 is a perspective detail view of the invention.

FIG. 7 is a section detail view of the invention along line 7-7 in FIG. 6.

FIG. 8 is a section detail view of the invention along line 8-8 in FIG. 1.

FIG. 9 is a section detail view of the invention along line 9-9 in FIG. 6.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a mobile misting cooling apparatus comprising: a reservoir container; a pump connected to the reservoir container; tubing connected from the reservoir container to a pump inlet, and tubing extending out from a pump outlet upwards, wherein the tubing comprises holes along a surface operable to allow a liquid to extend out from the tubing to a plurality of misters, wherein the tubing is positioned along a mobile structure.

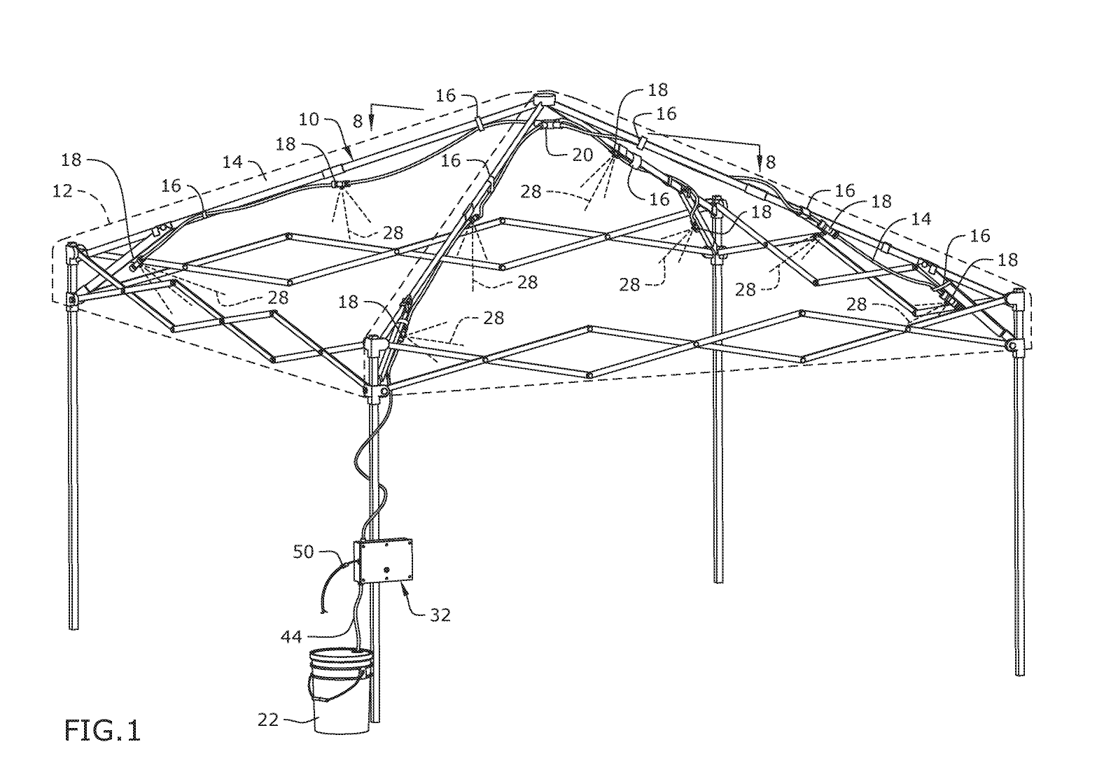

As is illustrated in FIG. 1, an apparatus of the present invention may be adapted to a portable or temporary structure, such as a tent frame 10. The portable structure 10, may include a covering, such as a tent canopy 12. Elements of the system and apparatus of the present invention may be fitted to the structure 10, which include tubing elements 14, which may be secured to the frame 10 via a plurality of straps 16. In a preferred embodiment of the invention, a plurality of tubing elements 14 are attached to each of a plurality of frame members that emanate from an apex of the frame 10. Alternatively, the tubing elements 14 may be secured to the lateral frame members of the frame 10.

A plurality of fittings, such as T-union fittings 18, interconnect the tubing elements 14 and a distribution connector 20, such as a cross connector show in reference to FIG. 8, that may distribute a cooling liquid, such as water, between legs of tubing elements 14. The Tubing elements 14 carry the cooling liquid delivered from a reservoir 22, under pressure provided by a pump 24 and dispersed as a liquid mist 28 to provide a cooling environment.

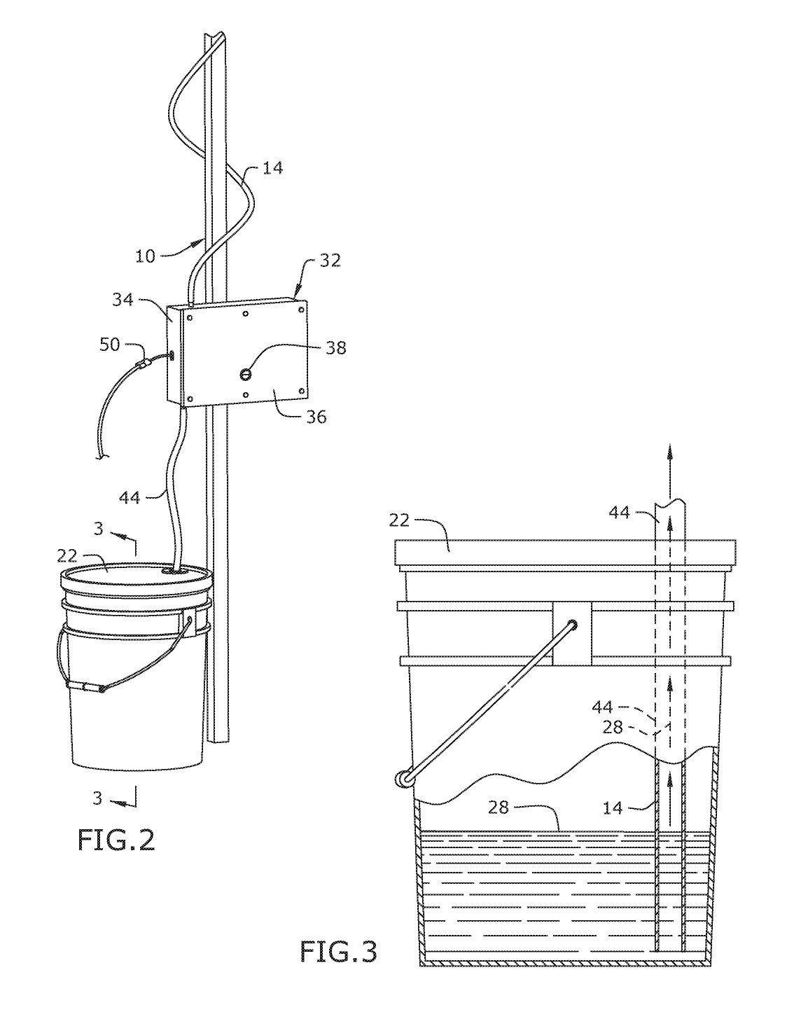

As seen in reference to FIGS. 2 and 3, the reservoir container 22 may include an opening which receives a reservoir feed tube 44 to convey the cooling liquid 28 to an inlet the pump 24. The reservoir opening should have a sufficient size to permit the filling of the reservoir container with the cooling liquid 28 for initial operational state and replenishment of the cooling liquid 28 as it is depleted during operation. The reservoir container 22 may be any suitable container for holding a volume of cooling liquid, such as a large bucket, ice chest, and the like. The reservoir feed tube 44 may enter into the opening of the reservoir container 22 and have a first end that extends to a bottom of the reservoir and a second end to connect to a pump inlet. In certain embodiments, the tubing 44 may be approximately ⅝″ in thickness for the portion connecting the reservoir container 22 and the pump 24.

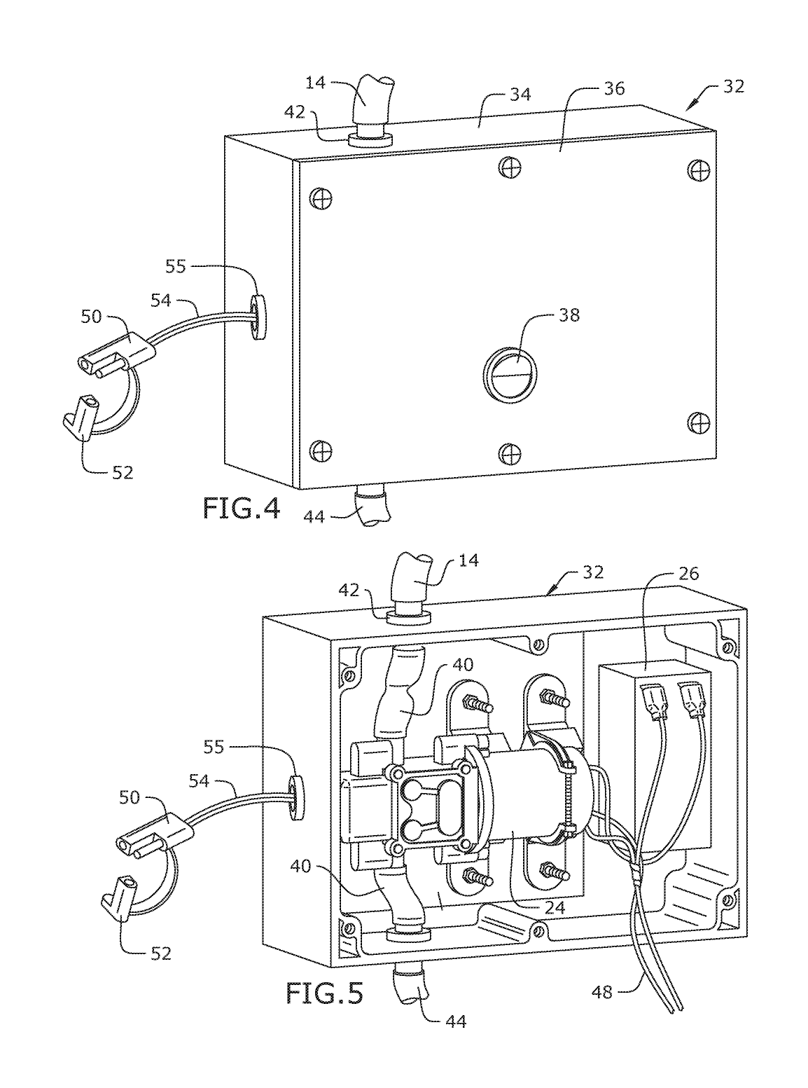

As seen in reference to FIGS. 2, 4, and 5, the pump 24 may be a manual or a powered pump, and may, for example be powered through a battery 26 or the like and may have an activation switch 38, such as an on/off switch. The pump 24, battery 26, and activation switch 38 may be contained within a housing 32, comprising a housing body 34 and a housing lid 36, preferably the housing 32 is water proof. An internal tubing 40 may interconnect the pump 24 with a housing coupler 42. The housing couplers 42 provide for connection of the tubing 14 and the reservoir feed tube 44 when setting up and operating the system.

The housing 32 may also include an external power connector 50, which may include a protective cap 52 to prevent exposure to the elements when not in use. The connector 50 may be connectable to a power source to recharge the battery 26, or alternatively to power the pump 24. Wiring 54 conducts the external power applied to the connector 50 to the internal wiring 48 of the housing, and may be sealed by an O-ring, or suitable seal 55.

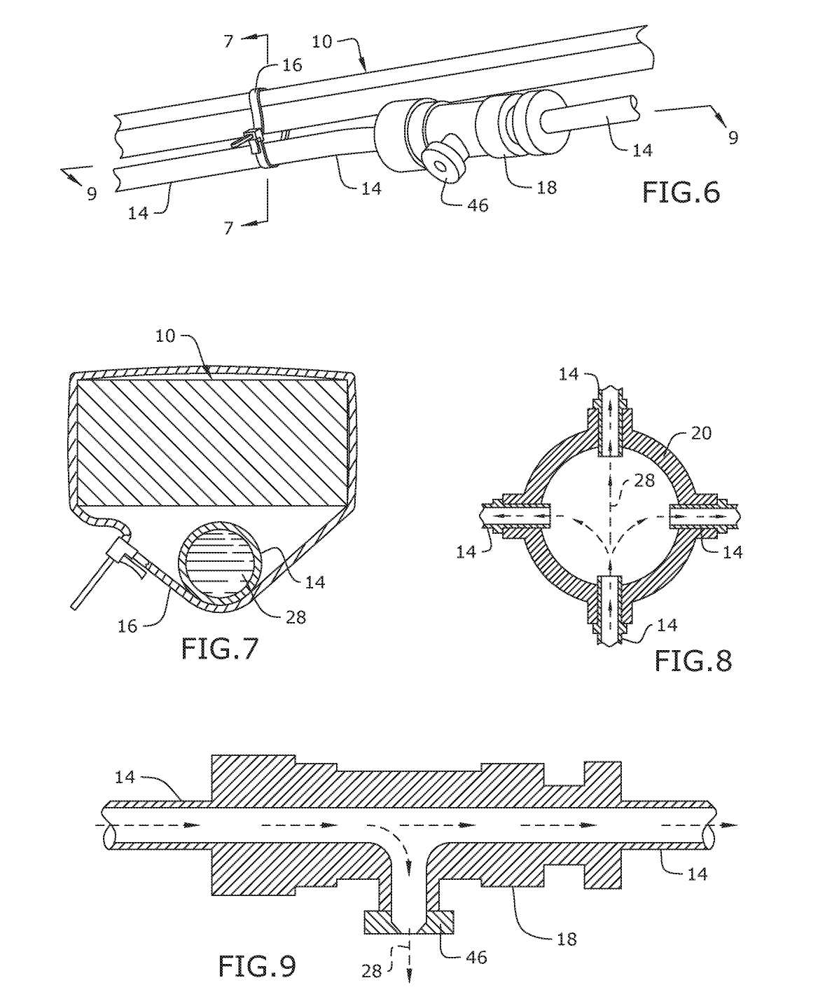

As seen in reference to FIGS. 6 and 7, the tubing 14 may extend from the pump outlet and is secured to the frame 10 via a plurality of straps 16. Straps 16 may be any suitable material, such as a tie-wrap, a hook and pile strap, a buckled fabric strap, or the like. Preferably the tubing 14 is secured along the frame members 10, such that a misting element 46 is directed towards the interior space defined beneath the canopy 12, as best seen in reference to FIG. 6. A plurality of misters 46 may be attached to the tubing 14 at the T-union fittings 18 holes. The plurality of misters 46 may produce a light mist when the pump 24 may be turned on.

A method of using the apparatus may include the following. A user may fill the reservoir container 22 with a liquid such as water or the like. The user may then place the reservoir container 22 on the ground. The reservoir container 22 may be connected to the pump 24 inlet through the reservoir feed tube 44 and the tubing 14 is connected to the pump 24 outlet.

The housing 32 (inclusive of the housing body 34 and lid 36) may be removably attached to a mobile structure 10 such as a canopy or the like. The housing 32 (inclusive of the housing body 34 and lid 36) may be removably attached by straps, a clamp, or the like to a leg of the mobile structure 10. The tubing 14 may come out of the pump 24 and may be removably connected to the mobile structure 10 by a plurality of fasteners 16, or the like, such as hook and loop fasteners, and tie-wraps. Tubing 14 from the pump may be approximately ¼″ in thickness along at least one leg of the mobile structure 10. In a preferred embodiment, the tubing 14 may be reduced to approximately ⅛″ thickness along a top portion of the mobile structure 10. The tubing 14 may have the misters 46 disposed so that once the pump 24 starts running, the liquid from the reservoir container 22 may move through the tubing 14 exiting through the couplers 18 and liquid may run through the plurality of misters 46 that are attached to the couplers 18 and a light mists of the liquid may exit from the plurality of misters 46 onto anyone within and around the mobile structure 10.

It should be understood, of course, that the foregoing relates to exemplary embodiments of the invention and that modifications may be made without departing from the spirit and scope of the invention as set forth in the following claims.

What is claimed is:

1. A mobile cooling apparatus, comprising:
a portable liquid reservoir,
a pump, having an inlet and an outlet;
a rechargeable power connector attached to a battery;
a tubing element adapted to be coupled with an outlet of the pump; and
a plurality of misters adapted to be operatively coupled to the tubing element.

2. The mobile cooling apparatus of claim 1, further comprising:
a portable frame structure, wherein the plurality of misters are removably attached to the portable frame structure in a spaced apart relation.

3. The mobile cooling apparatus of claim 2, further comprising:
a fastener operable to removably attach the tubing element to the portable frame structure.

4. The mobile cooling apparatus of claim 3, wherein the fastener comprises a hook and pile strap.

5. The mobile cooling apparatus of claim 3, wherein the fastener comprises a tie-wrap.

6. The mobile cooling apparatus of claim 3, further comprising:
a distribution connector operatively connected between a plurality of tubing elements.

7. The mobile cooling apparatus of claim 2, further comprising:
a cooling fluid contained in the portable liquid reservoir.

8. The mobile cooling apparatus of claim 7, wherein the pump is adapted to communicate the cooling fluid through the plurality of misters.

9. The mobile cooling apparatus of claim 7, further comprising:
a pump housing containing the pump and an electrical source for powering the pump.

10. The mobile cooling apparatus of claim 9, wherein the electrical source comprises a battery contained within the pump housing.

11. The mobile cooling apparatus of claim 9, wherein the pump housing further comprises:
an external power connector, conducting an external electrical source to at least one of the pump or the battery.

12. A mobile misting cooling apparatus comprising:
a reservoir container;
a pump connected to the reservoir container;
a rechargeable power connector attached to a battery;
a plurality of misters; and
a tube connected to the pump and reservoir container, wherein the tube communicates a liquid from the tube to one of the plurality of misters.

13. The mobile misting cooling apparatus of claim 12, further comprising:
a frame structure, wherein the tube is removably attached to the frame structure.

14. The mobile misting cooling apparatus of claim 13, further comprising:
a canopy covering at least a top portion of the frame structure.

15. The mobile misting cooling apparatus of claim 14, further comprising:
a pump housing containing the pump and rechargeable power connector attached to an electrical source to operate the pump.

16. The mobile misting cooling apparatus of claim 15, further comprising:
a distribution connector, operatively connecting a plurality of tubes to allow distribution of the liquid between each of the plurality of tubes.
